(19) United States
(12) Patent Application Publication
(10) Pub. No.: US 2012/0062753 A1
(43) Pub. Date: Mar. 15, 2012

(54) IMAGE ENCODING INTEGRATED CIRCUIT AND ENCODED IMAGE DATA TRANSMISSION METHOD THEREOF

(76) Inventor: Pai-Chu HSIEH, Hsinchu City (TW)

(21) Appl. No.: 13/095,608

(22) Filed: Apr. 27, 2011

(30) Foreign Application Priority Data
Sep. 14, 2010 (TW) 099131093

(51) Int. Cl. H04N 5/225; H04N 7/26

(52) U.S. Cl. 348/207.1; 348/425.1; 348/E05.024; 375/E07.2

(57) ABSTRACT

An image encoding integrated circuit and an encoded image data transmission method thereof are provided. The image encoding integrated circuit is utilized in a webcam and includes a central processing unit, an image sensing control unit, an image encoder unit, a bit rate monitoring unit, a transmission unit, and a bit rate control unit. The central processing unit, the image sensing control unit, the bit rate monitoring unit, and the transmission unit respectively produce a demand adjustment signal, a sensing status signal, a bit rate signal, and a transmission status signal. The bit rate control unit utilizes at least one of the signals to produce a quantization parameter signal. The image encoding unit transmits encoded image data in a specific bit rate, wherein the bit rate is adjusted according to the quantization parameter signal. The output bit rate of the image encoding unit is adjusted in consideration of even more system parameters, so as to improve the efficiency of the bit rate control.

### BACKGROUND OF INVENTION

1. Field of the Invention

The present invention relates generally to an image encoding integrated circuit and an encoded image data transmission method thereof. Particularly, the present invention relates to an image encoding integrated circuit and an encoded image data transmission method thereof that considers even more parameters in adjusting bit rate in order to raise the efficiency of the bit rate control.

2. Description of the Prior Art

With the explosive technological advancement of digital imagery, numerous different types of digital imaging devices such as webcams and digital cameras are continuously being innovated. The fierce market competition of these digital imaging devices can best be exemplified by the frequent conventions held for introducing new products. In order to let their respective products stand out among all other competitors' products in the fiercely competitive market, digital imaging device manufacturers improve to their utmost their products' features and performance. Within many related technologies, image compression is a primary factor contributing to improving the performance of digital imaging devices.

FIG. 1 is a schematic diagram of a conventional image encoding integrated circuit. As shown in FIG. 1, in systems utilizing H.264 image compression standards, an image sensing control unit 2 of the image encoding integrated circuit 1 converts image signals from an external image sensor 3 to image data and then stores the image data in an external memory 4. An entropy encoder 5 of the image encoding integrated circuit 1 retrieves and encodes the image data from the external memory 4. A bit rate monitor 6, connected to the output end of entropy encoder 5, is responsible for transmitting image data to a transmission device 7 for further transmission processing. The bit rate monitor 6 is also responsible for comparing the quantity differences in the image data created by the entropy encoder 5 and the image data that can be processed by the transmission device 7 in order to create a quantization parameter signal S based on the comparison.

In the H.264 image compression standard, the bit rate monitor 6 is realized as a video buffer verifier. The bit rate monitor 6 will transmit a transmission status signal T that consists of status signals, such as whether the buffer is filled or not and other related signals, back to a bit rate controller 8, which in turn allows the bit rate controller 8 to make adjustments to the quantization parameter in consideration of the signal T. The bit rate controller 8 then sends the adjusted quantization parameter signal S that includes the adjusted quantization parameter to the entropy encoding unit 5. The bit rate at which the encoded image data is transmitted from the entropy encoding unit 5 changes accordingly to changes in the quantization parameter in order to adjust the transmission rate of encoded image data outputted from the entropy encoding unit 5 to match the processing speed of the transmission device 7.

However, image encoding integrated circuits that are currently realized with System-on-a-chip (SoC) configuration are gradually becoming the universal standard. Due to the fact that there exists even greater amounts of hardware and software components in the SoC configuration, the original method of utilizing the quantization parameter signal S created from the bit rate monitor 6 to calibrate the quantization parameter is significantly insufficient.

### SUMMARY OF INVENTION

It is an object of the present invention to provide a high resolution image encoding integrated circuit and an encoded image data transmission method thereof. Compared to the prior art, the adjustment of bit rate of the present invention considers even more system parameters, so as to improve the efficiency of the bit rate control.

The present invention achieves these and other objectives by providing an image encoding integrated circuit for use in a webcam. The image encoding integrated circuit includes a central processing unit (CPU), an image sensing control unit, an image encoding unit, a bit rate monitoring unit, a bit rate control unit, and a transmission unit. The central processing unit receives a demand signal and creates a demand adjustment signal based on the demand signal. The image sensing control unit receives and converts an image signal to an image data and then creates a sensing status signal based on the image signal. The image encoding unit converts the image data into an encoded image data. The bit rate monitoring unit receives and stores the encoded image data from the image encoding unit. The transmission unit outputs the encoded image data received from the bit rate monitoring unit and creates a transmission status signal based on the transmission status of the encoded image data. The bit rate monitoring unit creates a bit rate signal based on the transmission status of the transmission unit receiving the encoded image data. The bit rate control unit creates a quantization parameter signal based on at least one of the demand adjustment signal, the sensing status signal, the transmission status signal, and the bit rate signal. The image encoding unit transmits the encoded image data in a specific bit rate, wherein the bit rate is adjusted based on the quantization parameter signal. The image encoding integrated circuit of the present invention adjusts the output bit rate of the image encoding unit in consideration of even more system parameters, and thus increases the efficiency of the bit rate control.

The encoded image data transmission method of the present invention is provided for an image encoding integrated circuit used in a webcam. The encoded image data transmission method includes the following steps: receiving a demand signal from an external host and creating a demand adjustment signal based on the demand signal; converting an image signal generated by the image sensing unit to an image data, and then creating a sensing status signal based on the image data; converting the image data to an encoded image data, and then transmitting the encoded image data in a specific bit rate, wherein the bit rate is adjusted according to a quantization parameter signal; storing the encoded image data, and then creating a bit rate signal based on the receiving status of the stored encoded image data; receiving the stored encoded image data and transmitting the encoded image data to the external host, and then creating a transmission status signal based on the transmission status of the encoded image data; and creating a quantization parameter signal based on at least one of the demand adjustment signal, the sensing status signal, the bit rate signal, and the transmission status signal. The encoded image data transmission method adjusts the output bit rate of the image encoding integrated circuit in consideration of even more system parameters, and thus increases the efficiency of the bit rate control.

### BRIEF DESCRIPTION OF THE DRAWINGS

FIG. 1 is a schematic diagram of a conventional image encoding integrated circuit;

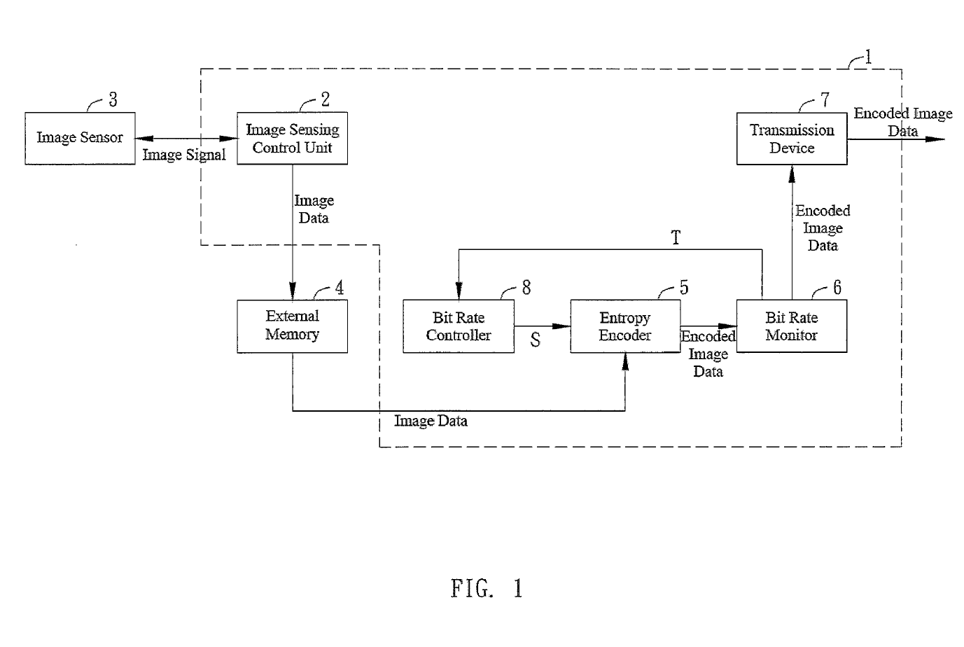

FIG. 2A is a schematic diagram depicting an embodiment of an image encoding integrated circuit;

FIG. 2B is a schematic diagram of an embodiment of signal transmission of the image encoding integrated circuit of FIG. 2A;

FIG. 3A is a schematic diagram of an embodiment of operating system signal transmission of the image encoding integrated circuit of FIG. 2A;

FIG. 3B is a schematic diagram of an embodiment of application signal transmission of the image encoding integrated circuit of FIG. 2A; and

FIG. 4 is a flowchart diagram of an embodiment of the encoded image data transmission method.

### DETAILED DESCRIPTION OF THE PREFERRED EMBODIMENT

The present invention provides an image encoding integrated circuit and an encoded image data transmission method thereof. In a preferred embodiment, the image encoding integrated circuit and the encoded image data transmission method thereof are utilized in digital image encoding standards with high compression rates (such as H.264, etc.) for image encoding in high resolution image encoding. The encoded image data transmission method is utilized in the image encoding integrated circuit.

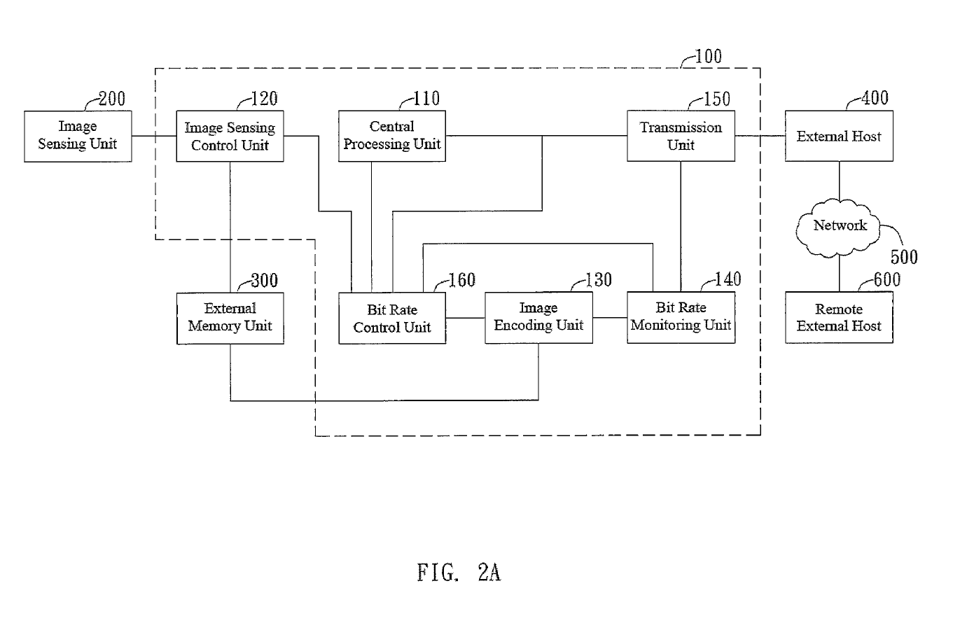

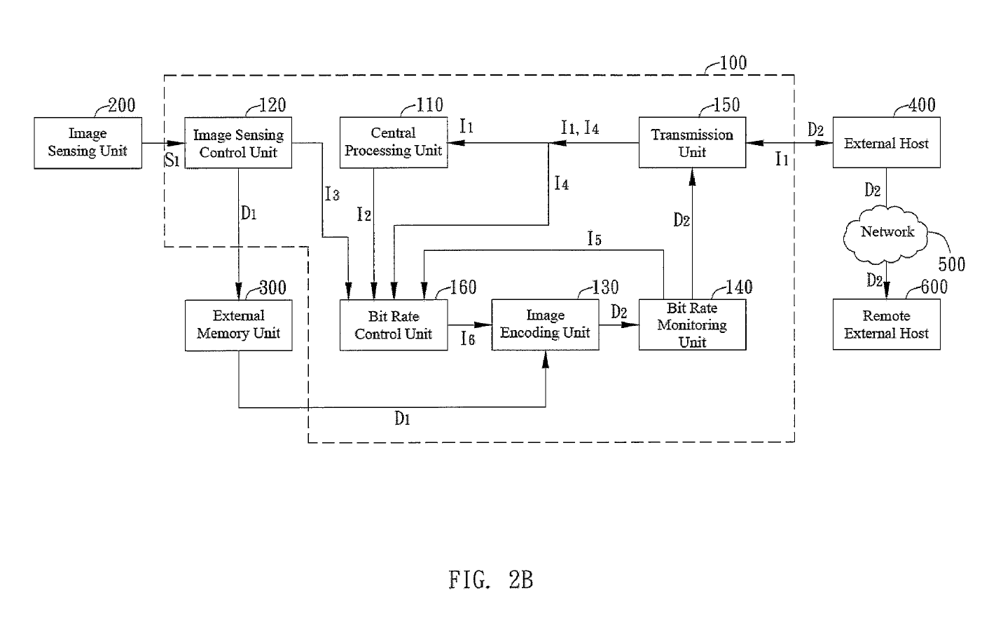

FIG. 2A is a schematic diagram of an embodiment of the image encoding integrated circuit of the present invention. FIG. 2B is an embodiment of signal transmission of the image encoding integrated circuit of FIG. 2A. The image encoding integrated circuit is preferably utilized in a webcam that is implemented in a personal computer, a laptop computer, a television set, or other related devices. As shown in FIGS. 2A and 2B, the image encoding integrated circuit 100 includes a central processing unit 110, an image sensing control unit 120, an image encoding unit 130, a bit rate monitoring unit 140, a transmission unit 150, and a bit rate control unit 160. The central processing unit 110 receives a demand signal I₁, wherein the demand signal I₁ represents a request for the output bit rate of the image encoding unit 130 from an external host that is connected to the image encoding integrated circuit 100. The central processing unit 110 then generates a demand adjustment signal I₂ based on the demand signal I_{I} and sends the demand adjustment signal I₂ to the bit rate control unit 160. The image sensing control unit 120 receives an image signal S₁ generated from the image sensing unit 200 and converts the image signal S₁ to image data D₁ in an analog-to-digital method or other such conversion methods. The image sensing control unit 120 then stores the image data D₁ in an external memory unit 300 and then creates a sensing status signal I₃ based on the image signal S₁. The sensing status signal I₃ corresponds to the status of the image signal S₁ and is sent to the bit rate control unit 160. The image encoding unit 130 then converts the image data D₁ retrieved from the external memory unit 300 to encoded image data D₂ by compression, encoding, or any other related method. The bit rate monitoring unit 140 receives and stores the encoded image data D₂ from the image encoding unit 130 and creates a bit rate signal I₅. The bit rate signal I₅ corresponds to the receiving status of the encoded image data D₂ in the transmission unit 150 and is sent to the bit rate control unit 160. In the present embodiment, the bit rate monitoring unit 140 includes a video buffer verifier (VBV). However, in other embodiments, other storage buffering apparatuses may be utilized.

The transmission unit 150 outputs the encoded image data D₂ received from the bit rate monitoring unit 140. The transmission unit 150 generates a transmission status signal I₄ based on the transmission status of the encoded image data D₂ and then transmits the transmission status signal I₄ to the bit rate control unit 160. In the present embodiment, the transmission unit 150 is a Universal Serial Bus (USB) interface. However, in other embodiments, other forms of connection interfaces may be utilized. The bit rate control unit 160 creates a quantization parameter signal I₆ based on at least one of the demand adjustment signal I₂, the sensing status signal I₃, the transmission status signal I₄, and the bit rate signal I₅, wherein the quantization parameter signal I₆ includes the quantization parameter. The image encoding unit 130 utilizes a specific bit rate to transmit the encoded image data D₂, wherein the bit rate is adjusted according to the quantization parameter in the quantization parameter signal I₆. In the present embodiment, the quantization parameter is inversely proportional to the bit rate of the image encoding unit 130. That is, increasing the quantization parameter will correspondingly reduce the bit rate of the image encoding unit 130, and decreasing the quantization parameter will correspondingly increase the bit rate of the image encoding unit 130. However, in other embodiments, the quantization parameter may be directly proportional to the bit rate of the image encoding unit 130. That is, increasing the quantization parameter will correspondingly increase the bit rate of the image encoding unit 130, and decreasing the quantization parameter will correspondingly reduce the bit rate of the image encoding unit 130. The image encoding integrated circuit of the present invention adjusts the output bit rate of the image encoding unit in consideration of even more system parameters, and thus increases the efficiency of the bit rate control.

Under low luminance conditions, much more noises are generated by the image sensing unit 130. The greater quantity of noise results in the image encoding unit 130 correspondingly generating greater amounts of data. Therefore, after the image sensing control unit 120 analyzes the image signals S₁ from the image sensing unit 200 and concludes that the present image brightness is dimmer and the quantity of noise is higher, by way of the sensing status signal I₃, the control unit 160 can increase in advance the quantization parameter of the quantization parameter signal I₆ in order to decrease the bit rate of the image encoding unit 130. It is not necessary to wait until the bit rate monitoring unit 140 perceives that the encoded image data D2 of the image encoding unit 130 is greater in quantity than the manageable quantity of the transmission unit 150, and by way of the bit rate signal I₅ the bit rate control unit 160 increases the quantization parameter of the quantization parameter signal I₆ to reduce the bit rate of the image encoding unit 130. By notifying the control unit 160 to increase in advance the quantization parameter, the bit rate control unit 160 can more efficiently manage the bit rate of the image encoding 130 to match the transmission speed of the encoded image data D₂ in the transmission unit 150.

As shown in FIGS. 2A and 2B, in the present embodiment, the transmission unit 150 of the webcam 100 connects to an external host 400, allowing the encoded image data D2 to be transmitted through the network 500 from the external host 400 to a remote external host 600. The external host 400 may be a personal computer, a laptop computer, or any other related electronic devices. The network 500 may be an Ethernet or other related computer network. A transmission unit 150 realized with a Universal Serial Bus (USB) interface will detect when the bandwidth of the network 500 decreases to the point where the encoded image data D₂ is unable to fully transmit. The transmission unit 150 notifies the central processing unit 110 through the demand signal I₁ while also concurrently notifying the bit rate control unit 160 through the transmission status signal I₄ to decrease the bit rate of the image encoding unit 130 and in turn the amount of encoded image data D₂ outputted from the transmission unit 150. Therefore in the preferred embodiment, the generated transmission signal I₄ should consider the transmission status of the encoded image data D₂ between the transmission unit 150 and the external host 400, as well as the transmission status of the encoded image data D₂ in the network 500. However, in other embodiments, only one or the other may be considered based on the demand requirements.

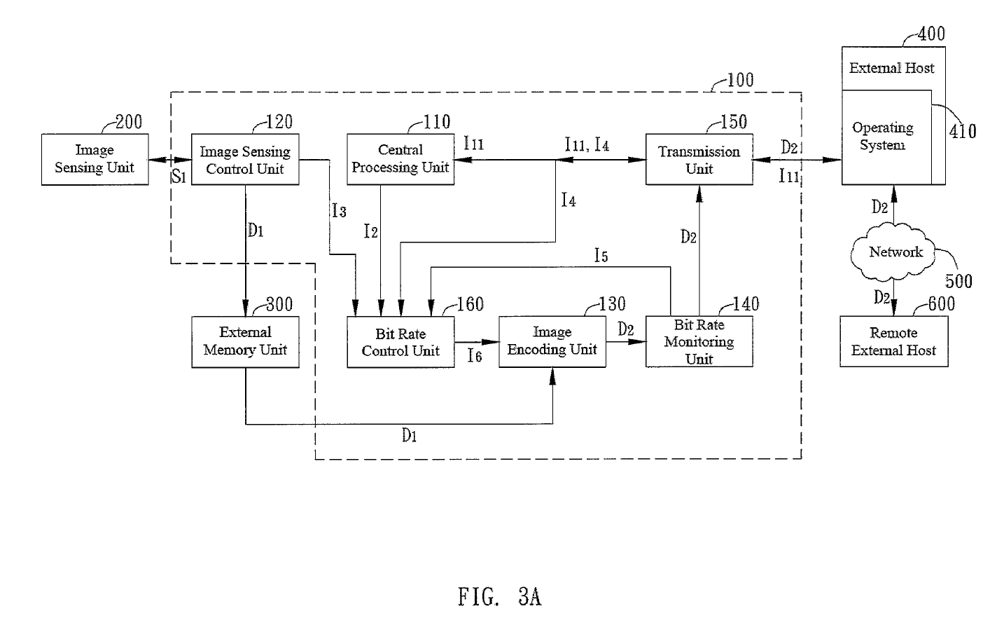

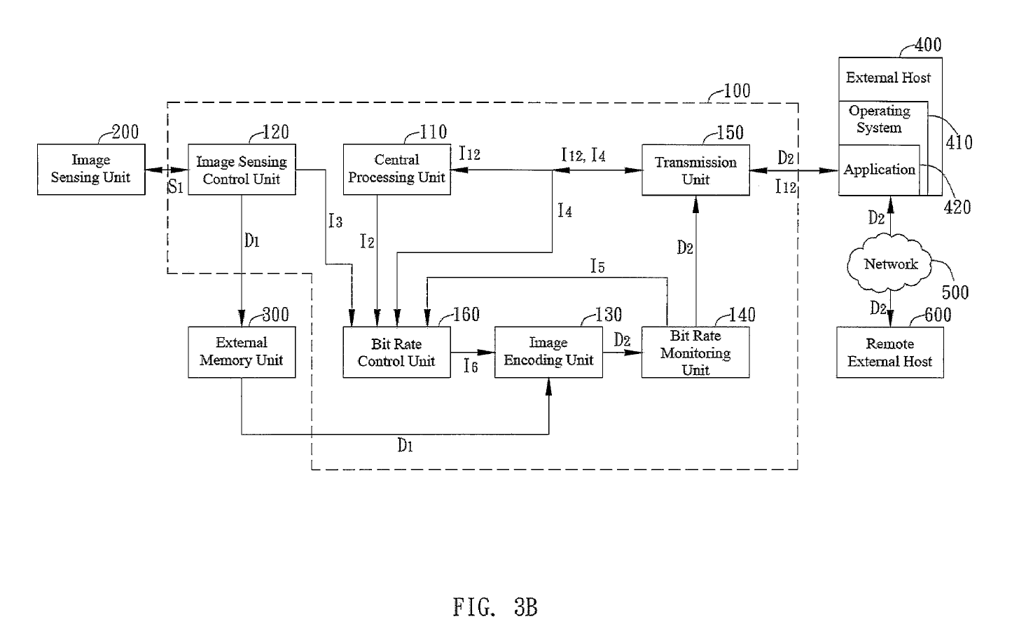

The central processing unit 110 receives through the transmission unit 150 the demand signal I₁ from the external host 400. The demand signal I_{I} includes at least one of an operating system signal I₁₁ or an application signal I₁₂. FIG. 3A illustrates an embodiment of operating system signal transmission of the image encoding integrated circuit of FIG. 2A. As shown in FIG. 3A, when the operating system 410 of the external host 400 finds out that the central processing unit (CPU) of the external host 400 has limited resources to process the data-intensive encoded image data D₂, the operating system 410 may transmit back to the image encoding integrated circuit 100 the operating system signal I₁₁, forcing the bit rate control unit 160 to increase the quantization parameter of the quantization signal I₆ in order to decrease the bit rate of the image encoding unit 130.

Image transmission applications running on the external host 400 (for example, Skype) may dynamically set at the time of occurrence the transmission rate of the encoded image data D₂ in the image encoding integrated circuit 100 in accordance or consideration to the operating system status, network bandwidth, user demands, and other such factors. FIG. 3B is an embodiment of application signal transmission of the image encoding integrated circuit of FIG. 2A. As shown in FIG. 3B, when the application 420 is setting the transmission rate, the external host 400 can correspondingly transmit back an application signal I₁₂ to notify the bit rate control unit 160 to either increase the quantization parameter of quantization parameter signal I₆ in order to decrease the bit rate of the image encoding unit 130, or to decrease the quantization parameter to increase the bit rate in order to satisfy the application demands for high transmission rates or high image resolutions and other such high resolution requirements.

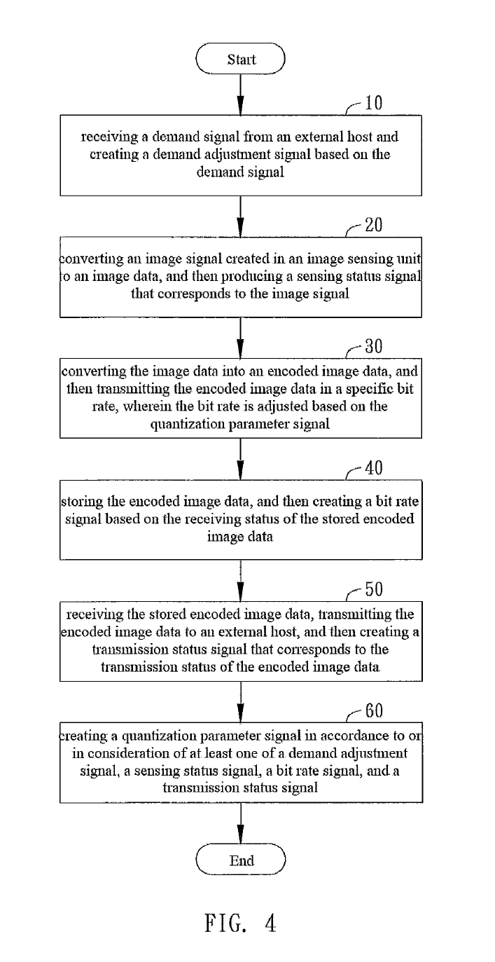

FIG. 4 is a flow chart of an embodiment of the encoded image data transmission method of the present invention. The method is preferably for use in image encoding integrated circuits of webcams. As shown in FIG. 4, the encoded image data transmission method includes, but is not limited to the following steps. Step 10 involves receiving a demand signal from an external host and creating a demand adjustment signal based on the demand signal. The demand signal represents a request for the output bit rate of the image encoding unit from an external device connected to the image encoding integrated circuit. In preferred embodiments, the demand signal includes at least one of an operating system signal and an application signal. As previously described, when the operating system of the external host finds out that the central processing unit (CPU) of the external host has limited resources to process the data-intensive encoded image data, the operating system may transmit back to the image encoding integrated circuit the operating system signal, forcing the bit rate control unit to increase the quantization parameter of the quantization signal in order to decrease the bit rate of the image encoding unit. Image transmission applications running on the external host (for example, Skype) may dynamically set at the time of occurrence the transmission rate of the encoded image data in the image encoding integrated circuit in accordance or consideration to the operating system status, network bandwidth, user demands, and other such factors. When the application is setting the transmission rate, the external host can correspondingly transmit back an application signal to notify the bit rate control unit to either increase the quantization parameter of quantization parameter signal in order to decrease the bit rate of the image encoding unit, or to decrease the quantization parameter to increase the bit rate in order to satisfy the application demands for high transmission rates or high image resolutions and other such high resolution requirements.

Step 20 involves converting an image signal created in an image sensing unit to an image data, and then producing a sensing status signal that corresponds to the image signal. The conversion is carried out utilizing analog-to-digital conversion method or any other related methods of conversion. Step 30 involves converting the image data into an encoded image data, and then transmitting the encoded image data in a specific bit rate, wherein the bit rate is adjusted based on the quantization parameter signal. The mentioned conversion is accomplished by compressing, encoding, or any other related means. Step 40 involves storing the encoded image data, and then creating a bit rate signal based on the receiving status of the stored encoded image data. Step 50 involves receiving the stored encoded image data, transmitting the encoded image data to an external host, and then creating a transmission status signal that corresponds to the transmission status of the encoded image data. In the present embodiment, the image encoding integrated circuit of the webcam connects to the external host, allowing the encoded image data to be further transmitted through the network that is connected to the external host to a remote external host(refer to the embodiment illustrated in FIGS. 2A and 2B). Therefore, Step 50 preferably can produce the transmission status signal in reference to the network transmission status of the encoded image data. Step 60 involves creating a quantization parameter signal in accordance to or in consideration of at least one of a demand adjustment signal, a sensing status signal, a bit rate signal, and a transmission status signal. The encoded image data transmission method of the present invention adjusts the output bit rate of the image encoding unit in consideration of even more system parameters, and thus increases the efficiency of the bit rate control as a result.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. An image encoding integrated circuit for use in a webcam, comprising:
a central processing unit for receiving at least one demand signal and creating a demand adjustment signal based on the demand signal;
an image sensing control unit for receiving an image signal and converting the image signal to at least one image data, the image sensing control unit creating a sensing status signal based on the image signal;
an image encoding unit for converting the image data to at least one encoded image data;
a bit rate monitoring unit for receiving and storing the encoded image data from the image encoding unit;
a transmission unit for outputting the encoded image data received from the bit rate monitoring unit and creating a transmission status signal based on a transmission status of the encoded image data, the bit rate monitoring unit creating a bit rate signal based on a receiving status of the encoded image data by the transmission unit; and
a bit rate control unit for creating a quantization parameter signal based on at least one of the demand adjustment signal, the sensing status signal, the transmission status signal, and the bit rate signal, wherein the image encoding unit transmits the encoded image data in a bit rate, wherein the bit rate is adjusted according to the quantization parameter signal.

2. The image encoding integrated circuit of claim 1, wherein the bit rate monitoring unit comprises a Video Buffer Verifier (VBV).

3. The image encoding integrated circuit of claim 1, wherein the webcam is connected to an external host, the encoded image data is transmitted to a remote external host through a network connected to the external host, the transmission unit further creates a transmission status signal based on a transmission status of the encoded image data in the network.

4. The image encoding integrated circuit of claim 1, wherein the webcam connects to at least one external host, the central processing unit receives the demand signal from the external host.

5. The image encoding integrated circuit of claim 4, wherein the demand signal comprises at least one of an operating system signal and an application signal.

6. An encoded image data transmission method for an image encoding integrated circuit used in a webcam, comprising:
receiving at least one demand signal from an external host and creating a demand adjustment signal based on the demand signal;
converting an image signal generated by an image sensing unit to at least one image data, and creating a sensing status signal based on the image signal;
converting the image data to at least one encoded image data and transmitting the encoded image data in a bit rate, wherein the bit rate is adjusted according to a quantization parameter signal;
storing the encoded image data and creating a bit rate signal based on a receiving status of the stored encoded image data;
receiving the stored encoded image data and transmitting the encoded image data to the external host, and creating a transmission status signal based on a transmission status of the encoded image data; and
creating a quantization parameter signal based on at least one of the demand adjustment signal, the sensing status signal, the bit rate signal, and the transmission status signal.

7. The encoded image data transmission method of claim 6, wherein the encoded image data is transmitted to a remote external host through a network connected to the host, the transmission step of the encoded image data to the external host computer further comprises creating the transmission status signal based on a transmission status of the encoded image data in the network.

8. The encoded image data transmission method of claim 6, wherein the demand signal comprises at least one of an operating system signal and an application signal.
